(19) United States
(12) Patent Application Publication
(10) Pub. No.: US 2018/0151315 A1
(43) Pub. Date: May 31, 2018

(54) LUMINOUS KEYBOARD

(71) Applicant: PRIMAX ELECTRONICS LTD., Taipei (TW)

(72) Inventor: YING-TE CHIANG, Taipei (TW)

(21) Appl. No.: 15/434,143

(22) Filed: Feb. 16, 2017

(30) Foreign Application Priority Data
Nov. 25, 2016 (TW) 105218074

(51) Int. Cl. H01H 13/83; F21V 8/00; H01H 13/14

(52) U.S. Cl. CPC H01H 13/83; H01H 13/14; G02B 6/0091; G02B 6/0035

(57) ABSTRACT

A luminous keyboard includes plural keys, a light-emitting element, a light guide plate and a supporting plate. The light-emitting element emits light beams. The light guide plate includes plural light-guiding parts for guiding the light beams. The supporting plate includes a plate body, plural openings and plural sheltering walls. The openings run through the plate body and are aligned with the corresponding light-guiding parts. After the light beams are guided to pass through the openings by the light-guiding parts, the light beams are projected to the keys. The sheltering walls are disposed on the plate body and located beside the corresponding openings. The light beams and the light-guiding parts corresponding to the light beams are sheltered by the sheltering walls.

### FIELD OF THE INVENTION

The present invention relates to a keyboard, and more particularly to a luminous keyboard with an illuminating function.

### BACKGROUND OF THE INVENTION

Generally, the widely-used peripheral input device of a computer system includes for example a mouse device, a keyboard, a trackball device, or the like. Via the keyboard, characters and symbols can be inputted into the computer system directly. As a consequence, most users and most manufacturers of input devices pay much attention to the development of keyboards.

FIG. 1 is a schematic top view illustrating the outer appearance of a conventional keyboard. As shown in FIG. 1, there are plural keys 10 on a surface of the conventional keyboard 1. These keys 10 are classified into several types, e.g. ordinary keys 101, numeric keys 102 and function keys 103. When one of these keys 10 is depressed by the user's finger, a corresponding signal is issued to the computer, and thus the computer executes a function corresponding to the depressed key. For example, when an ordinary key 101 is depressed, a corresponding English letter or symbol is inputted into the computer. When a numeric key 102 is depressed, a corresponding number is inputted into the computer. In addition, the function keys 103 (F1-F12) can be programmed to provide various functions. For example, the conventional keyboard 1 is a keyboard for a notebook computer.

With the maturity of the computing technologies, the keyboard manufacturers make efforts in designing novel keyboards with special functions in order to meet diversified requirements of different users. For this reason, luminous keyboards are favored by users. The outer appearance of the conventional luminous keyboard is substantially similar to the outer appearance of the conventional keyboard 1. Since the luminous keyboard provides the function of illuminating the keys, the inner structure of the luminous keyboard is different from the inner structure of the keyboard without the illuminating function. Hereinafter, the inner structure of the luminous keyboard will be illustrated in more details. FIG. 2 is a schematic cross-sectional view illustrating a conventional luminous keyboard. As shown in FIG. 2, the conventional luminous keyboard 2 comprises plural keys 20, a membrane switch circuit member 21, a light guide plate 22, a backlight module 23, a supporting plate 24, a reflecting plate 25 and a base plate (not shown). Each key 20 comprises a keycap 201, a scissors-type connecting element 202 and an elastic element 203. From top to bottom, the keycap 201, the scissors-type connecting element 202, the elastic element 203, the membrane switch circuit member 21, the supporting plate 24, the light guide plate 22, the reflecting plate 25 and the base plate of the conventional luminous keyboard 2 are sequentially shown. The backlight module 23 is located at a side of the membrane switch circuit member 22. For example, the conventional luminous keyboard 2 is a keyboard for a notebook computer (not shown), and the base plate is installed on the notebook computer.

In the key 20, the keycap 201 is exposed outside the conventional luminous keyboard 2, so that the keycap 201 can be depressed by the user. The scissors-type connecting element 202 is used for connecting the keycap 201 and the supporting plate 24. The elastic element 203 is penetrated through the scissors-type connecting element 202. In addition, both ends of the elastic element 203 are contacted with the keycap 201 and the membrane switch circuit member 21, respectively. The membrane switch circuit member 21 comprises an upper wiring board 211, a spacer layer 212, and a lower wiring board 213. The upper wiring board 211, the spacer layer 212 and the lower wiring board 213 are all made of a light-transmissible material. The light-transmissible material is for example polycarbonate (PC) or polyethylene (PE). The upper wiring board 211 has plural upper contacts 2111. The spacer layer 212 is disposed under the upper wiring board 211, and comprises plural perforations 2121 corresponding to the plural upper contacts 2111. The lower wiring board 213 is disposed under the spacer layer 212, and comprises plural lower contacts 2131 corresponding to the plural upper contacts 2111. The plural lower contacts 2131 and the plural upper contacts 2111 are collectively defined as plural key switches 214.

The backlight module 23 comprises an illumination circuit board 231 and plural light-emitting elements 232. For clarification and brevity, only two light-emitting elements 232 are shown in the drawing. The illumination circuit board 231 is disposed under the membrane switch circuit member 21 for providing electric power to the plural light-emitting elements 232. The plural light-emitting elements 232 are disposed on the illumination circuit board 231. In addition, the plural light-emitting elements 232 are inserted into plural reflecting plate openings 251 of the reflecting plate 25 and plural light guide plate openings 221 of the light guide plate 22, respectively. By acquiring the electric power, the plural light-emitting elements 232 are driven to emit plural light beams B. Moreover, the plural light beams B are introduced into the light guide plate 22. For example, the plural light-emitting elements 232 are side-view light emitting diodes. The light guide plate 22 is used for guiding the plural light beams B to the keycaps 201. As shown in FIG. 2, the supporting plate 24 is arranged between the membrane switch circuit member 21 and the light guide plate 22 for supporting the keycap 201, the scissors-type connecting element 202, the elastic element 203 and the membrane switch circuit member 21. The reflecting plate 25 is disposed under the light guide plate 22 for reflecting the plural light beams B. Consequently, the plural light beams B are directed upwardly, and the utilization efficiency of the light beams B is enhanced. The two lateral edges 252 of the reflecting plate 25 are bent upwardly to enclose plural lateral edges 222 of the light guide plate 22. For clarification and brevity, only one lateral edge 252 of the reflecting plate 25 is shown in the drawing. Due to the lateral edges 252 of the reflecting plate 25, the problem of causing light leakage through the lateral edges 222 of the light guide plate 22 will be eliminated.

In the conventional luminous keyboard 2, each keycap 201 has a light-outputting zone 2011. The light-outputting zone 2011 is located at a character region or a symbol region of the keycap 201. Moreover, the position of the light-outputting zone 2011 is aligned with the position of a corresponding light-guiding dot 223 of the light guide plate 22. The light beams can be guided upwardly to the light-outputting zone 2011 by the corresponding light-guiding dot 223. The supporting plate 24 comprises plural supporting plate openings 241. The plural supporting plate openings 241 are aligned with corresponding light-guiding dots 223 and corresponding light-outputting zones 2011. On the other hand, since the membrane switch circuit member 21 is made of the light-transmissible material, the plural light beams B can be transmitted through the membrane switch circuit member 21. Consequently, after the plural light beams B are guided by the light-guiding dots 223, the plural light beams B are sequentially transmitted through the plural supporting plate openings 241 and the membrane switch circuit member 21 and directed to the plural light-outputting zones 2011, thereby illuminating the character region or the symbol region of the keycap 201. Under this circumstance, the illuminating function is achieved.

Generally, the supporting plate 24 is made of an opaque material. For example, the supporting plate 24 is made of a metallic material. Consequently, the plural light beams B are hindered by the supporting plate 24. In other words, the supporting plate 24 should have the plural supporting plate openings 241 for allowing the plural light beams B to go through.

However, the conventional luminous keyboard 2 still has some drawbacks. For example, the keycap 201 is installed on the supporting plate 24 through the scissors-type connecting element 202. Since there is a vacant space between the keycap 201 and the supporting plate 24, the light beams B are possibly leaked out through the lateral edges. Moreover, since the light beams B pass through the vacant space between the keycap 201 and the supporting plate 24, the profiles of the light-guiding dots 223 can be viewed by the user. For achieving the aesthetically-pleasing efficacy, it is preferred that the light-guiding dots 223 of the luminous keyboard 2 are not exposed.

### SUMMARY OF THE INVENTION

An object of the present invention provides a luminous keyboard for overcoming the lateral light leakage problem.

In accordance with an aspect of the present invention, there is provided a luminous keyboard. The luminous keyboard includes plural keys, a light-emitting element, a light guide plate and a supporting plate. The plural keys are exposed outside the luminous keyboard. The light-emitting element is located under the plural keys, and emits a light beam. The light guide plate is located under the plural keys and arranged beside the light-emitting element. The light guide plate includes plural light-guiding parts for guiding the light beam to the plural keys. The supporting plate is arranged between the plural keys and the light guide plate and connected with the plural keys. The supporting plate includes a plate body, at least one opening and at least one sheltering wall. The plate body is arranged between the plural keys and the light guide plate. The at least one opening runs through the plate body and is aligned with the corresponding light-guiding part. After the light beam passes through the at least one opening, the light beam is projected to at least one key of the plural keys. The at least one sheltering wall is disposed on the plate body and aligned with the at least one opening. The sheltering wall is arranged beside the opening. The light beam and the corresponding light-guiding parts are sheltered by the at least one sheltering wall.

From the above descriptions, the present invention provides a luminous keyboard. The supporting plate of the luminous keyboard is equipped with sheltering walls. The sheltering walls are located at the positions where the lateral light leakage possibly occurs. Consequently, the uses of the sheltering walls are capable of solving the lateral light leak problems. Moreover, the sheltering walls can shelter the light-guiding parts of the light guide plate. Since the light-guiding dots cannot be viewed by the user through the lateral edges of the keys, the aesthetically-pleasing efficacy can be achieved.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic top view illustrating the outer appearance of a conventional keyboard;

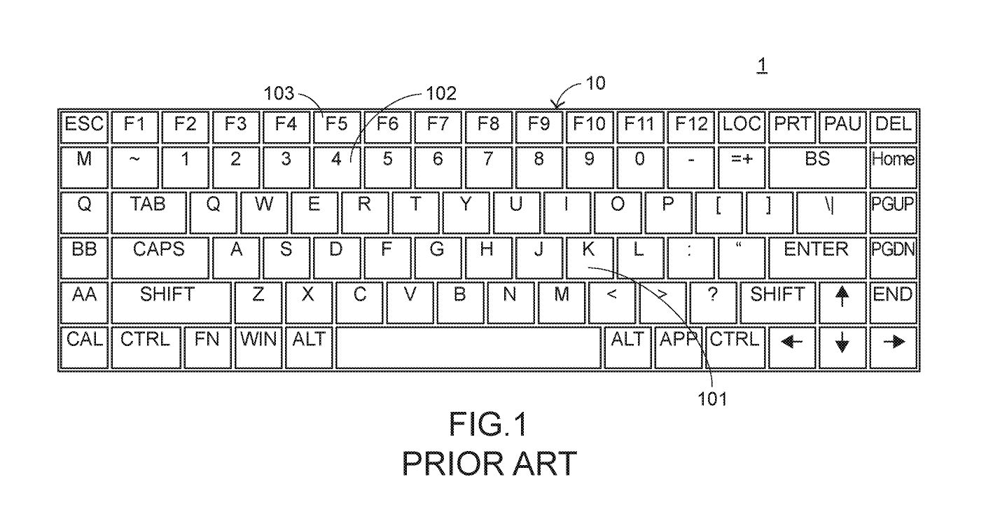

FIG. 2 is a schematic cross-sectional view illustrating a conventional luminous keyboard;

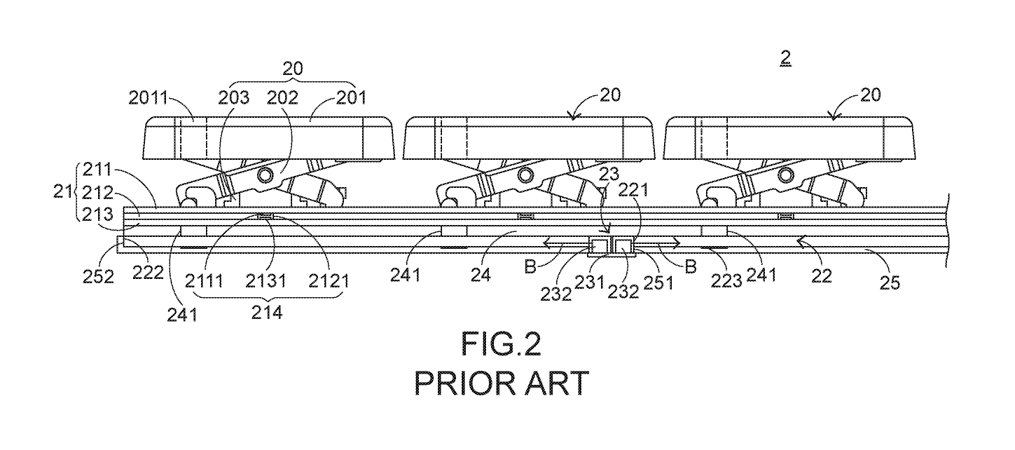

FIG. 3 is a schematic exploded view illustrating a portion of a luminous keyboard according to an embodiment of the present invention;

FIG. 4 is a schematic perspective view illustrating a portion of the supporting plate of the luminous keyboard according to the embodiment of the present invention;

FIG. 5 is a schematic cross-sectional view illustrating a portion of a luminous keyboard according to the embodiment of the present invention; and

FIG. 6 is a schematic perspective view illustrating a variant example of the supporting plate used in the luminous keyboard of the present invention.

### DETAILED DESCRIPTION OF THE PREFERRED EMBODIMENT

For overcoming the drawbacks of the conventional technology, the present invention provides a luminous keyboard.

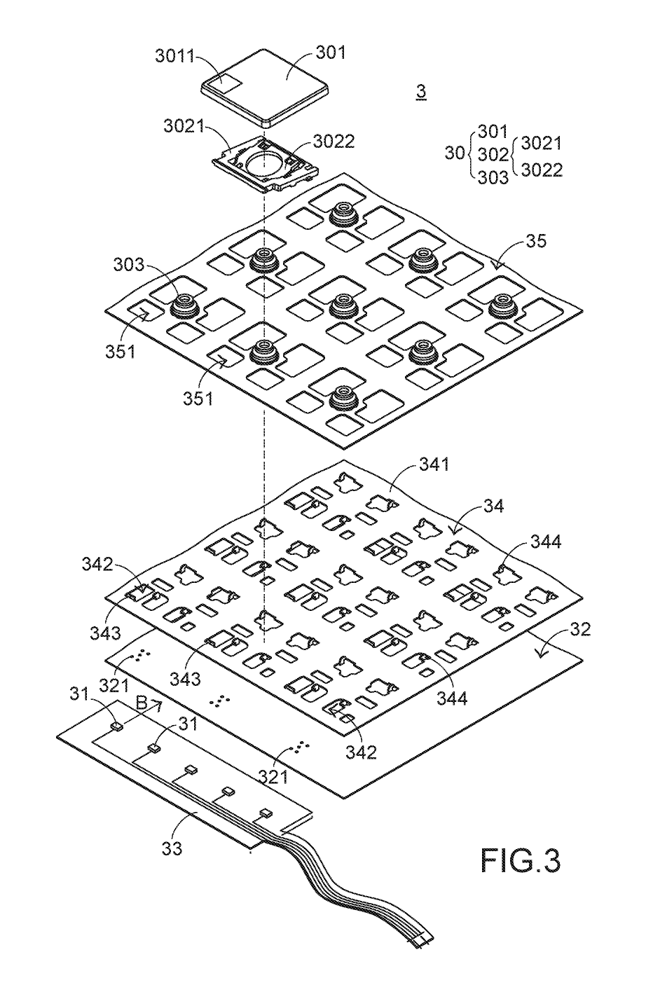

FIG. 3 is a schematic exploded view illustrating a portion of a luminous keyboard according to an embodiment of the present invention. As shown in FIG. 3, the luminous keyboard 3 comprises plural keys 30, plural light-emitting elements 31, a light guide plate 32, an illumination circuit board 33, a supporting plate 34 and a switch circuit board 35. The plural keys 30 are exposed outside the luminous keyboard 3. For succinctness, only one key 30 is shown in FIG. 3. Each key 30 comprises a keycap 301, a connecting element 302 and a triggering element 303. The plural light-emitting elements 31 are arranged below the plural keys 30 and disposed on the illumination circuit board 33. The plural light-emitting elements 31 emit plural light beams B. The light guide plate 32 is located under the plural keys 30 and arranged beside the plural light-emitting elements 31. The light guide plate 32 comprises plural light-guiding parts 321 for guiding the plural light beams B to the plural keys 30. The illumination circuit board 33 is arranged beside the light guide plate 32 for supporting the plural light-emitting elements 31 and providing electric power to the plural light-emitting elements 31. The switch circuit board 35 is disposed on the supporting plate 34. When the switch circuit board 35 is triggered by the plural keys 30, plural key signals are correspondingly generated. In this embodiment, the plural light-emitting elements 31 are side-view light emitting diodes, the illumination circuit board 33 is a flexible printed circuit (FPC), and the light-guiding parts 321 are V-cut structures or light-guiding dots.

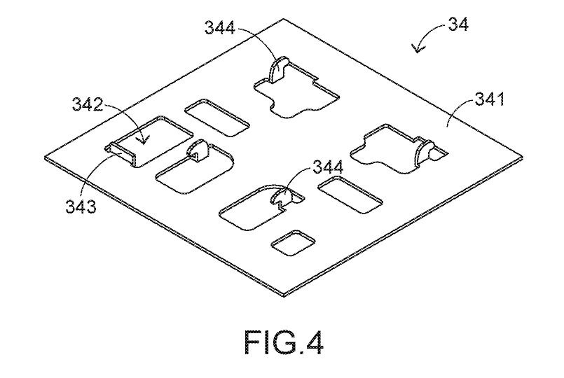

FIG. 4 is a schematic perspective view illustrating a portion of the supporting plate of the luminous keyboard according to the embodiment of the present invention. Please refer to FIGS. 3 and 4. The supporting plate 34 is arranged between the plural keys 30 and the light guide plate 32. The supporting plate 34 is connected with the plural keys 30 through the plural connecting elements 302. Moreover, the supporting plate 34 comprises a plate body 341, plural openings 342, plural sheltering walls 343 and plural supporting plate hooks 344. The plate body 341 is arranged between the plural keys 30 and the light guide plate 32. The plural openings 342 run through the plate body 341. Moreover, one opening 342 corresponds to one light-guiding part 321. After the light beams B pass through the opening 342, the light beams B are projected on the corresponding key 30. Moreover, one sheltering wall 343 corresponds to one opening 342. The sheltering wall 343 is arranged beside the corresponding opening 342 for sheltering the light beams B and the corresponding light-guiding parts 321. The plural supporting plate hooks 344 are bent structures that are extended from the plate body 341. Moreover, the plural supporting plate hooks 344 are connected with the plural keys 30. Like the plural supporting plate hooks 344, the plural sheltering walls 343 are also bent structures that are extended from the plate body 341. Preferably but not exclusively, the plural sheltering walls 343 and the plural supporting plate hooks 344 are integrally formed with the plate body 341. In some other embodiments, the plural sheltering walls and the plural supporting plate hooks are fixed on the plate body in various coupling means such as adhering means or engaging means.

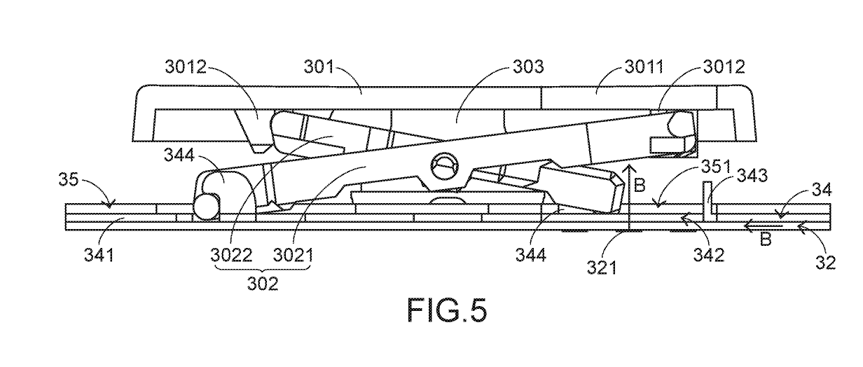

The structures of the keys 30 will be described in more details with reference to FIGS. 3 and 5. FIG. 5 is a schematic cross-sectional view illustrating a portion of a luminous keyboard according to the embodiment of the present invention. The keycap 301 of the key 30 is located over the supporting plate 34 and exposed outside the luminous keyboard 3. The keycap 301 comprises a light-outputting zone 3011 and plural keycap hooks 3012. One light-outputting zone 3011 corresponds to one opening 342. The light beams B from the light-emitting elements 31 are guided and projected to the light-outputting zone 3011. The light-outputting zone 3011 has a character profile or a symbol profile. The plural keycap hooks 3012 are protruded from an inner surface of the keycap 301. The connecting element 302 is arranged between the keycap 301 and the supporting plate 34. The keycap 301 is connected with the plural supporting plate hooks 344 of the supporting plate 34 through the connecting element 302. Consequently, the keycap 301 is moved upwardly or downwardly relative to the supporting plate 34. The triggering element 303 is arranged between the keycap 301 and the switch circuit board 35. When the triggering element 303 is pushed by the keycap 301, the corresponding key intersection (not shown) of the switch circuit board 35 is triggered.

The connecting element 302 comprises a first frame 3021 and a second frame 3022. A first end of the first frame 3021 is connected with the plural keycap hooks 3012 that are located at a first side of the keycap 301. A second end of the first frame 3021 is connected with the plural supporting plate hooks 344 that are located at a second side of the supporting plate 34. The second frame 3022 is connected with the first frame 3021. Moreover, the second frame 3022 is swingable relative to the first frame 3021. A first end of the second frame 3022 is connected with the plural supporting plate hooks 344 that are located at a first side of the supporting plate 34. A second end of the second frame 3022 is connected with the plural keycap hooks 3012 that are located at a second side of the keycap 301. In this embodiment, the luminous keyboard 3 is a keyboard for a notebook computer. The connecting element 302 is a scissors-type connecting element (also referred as a scissors leg structure) that is swung with the movement of the keycap 301. Moreover, the triggering element 303 is a rubbery elastomer. Preferably, the triggering element is a light-transmissible rubbery elastomer in order to prevent from blocking or absorbing the light beams.

Please refer to FIG. 3 again. The switch circuit board 35 comprises plural key intersections (not shown) and plural perforations 351. One perforation 351 corresponds to one light-outputting zone 3011. After the light beams B are guided to pass through the perforation 351, the light beams B are projected to the corresponding light-outputting zone 3011. In an embodiment, the switch circuit board 35 is a membrane switch circuit board.

The operating principles of depressing the keycaps 301 to trigger the switch circuit board 35 and generate the key signals are well known to those skilled in the art, and are not redundantly described herein. The illumination of the luminous keyboard 3 will be illustrated as follows. Please refer to FIG. 5. When the luminous keyboard 3 is driven and enabled, the plural light-emitting elements 31 emit the plural light beams B. After the plural light beams B are introduced into the light guide plate 32 from the edge of the light guide plate 32, the directions of the light beams B are changed by the light-guiding parts 321 of the light guide plate 35. Consequently, the light beams B are projected upwardly and exited from the light guide plate 32. After the light beams B are sequentially transmitted through the opening 342 of the supporting plate 34 and the perforation 351 of the light guide plate 35, the light beams B are outputted from the light-outputting zone 3011 of the keycap 301. Consequently, the luminous efficacy is achieved. While the process of travelling the light beams B, the sheltering walls 343 can shelter the light beams B. Consequently, the light beams B will not be leaked out through the leakage edges of the keys 30. Moreover, since the light-guiding parts 321 are sheltered by the lateral edges of the keys 30, the light-guiding parts 321 illuminated by the light beams B are no exposed.

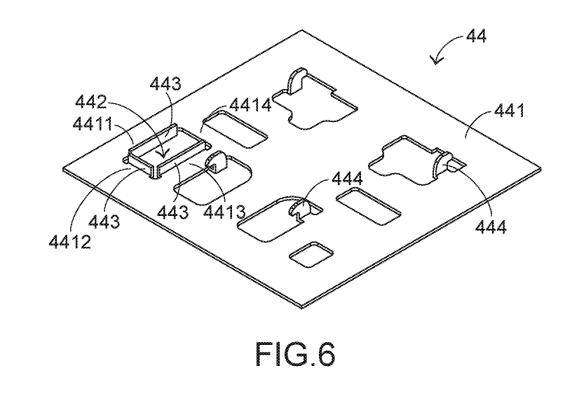

The following two aspects should be specially described. Firstly, the switch circuit board 35 comprises the plural perforations 351 for allowing the light beams B to pass through. Since the switch circuit board is light-transmissible, the perforations of the switch circuit board can be omitted. However, if the switch circuit board is not equipped with the perforations, the light utilization efficiency is slightly reduced. Moreover, the switch circuit board is selectively equipped with the perforations according to the practical requirements. In case that the switch circuit board is opaque, it is necessary to form the perforations in the switch circuit board. Secondly, in the above embodiment, the sheltering wall 343 is arranged beside one side of the corresponding opening 342 of the supporting plate 34. In another embodiment, four sheltering walls are respectively arranged beside four sides of the corresponding opening 342 in order for increasing the light-sheltering efficacy. Alternatively, the supporting plate has the structure as shown in FIG. 6.

Please refer to FIG. 6. The supporting plate 44 comprises a plate body 441, plural openings 442, plural sheltering walls 443 and plural supporting plate hooks 444. The sheltering walls 443 are located at a first side 4411, a second side 4412 and a third side 4413 of the opening 442. That is, one sheltering wall is not located at a fourth side 4414 of the opening 442. The supporting plate of FIG. 6 is suitably applied to the keyboard for a notebook computer or any other appropriate electronic device. The fourth side 4414 of the opening 442 faces a display screen (not shown) of the notebook computer. Since the display screen can shelter the light beams and the light-guiding parts, it is not necessary to install the sheltering wall at the fourth side 4414 of the opening 442.

From the above descriptions, the present invention provides a luminous keyboard. The supporting plate of the luminous keyboard is equipped with sheltering walls. The sheltering walls are located at the positions where the lateral light leakage possibly occurs. Consequently, the uses of the sheltering walls are capable of solving the lateral light leak problems. Moreover, the sheltering walls can shelter the light-guiding parts of the light guide plate. Since the light-guiding dots cannot be viewed by the user through the lateral edges of the keys, the aesthetically-pleasing efficacy can be achieved.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all modifications and similar structures.

1. A luminous keyboard, comprising:
plural keys exposed outside the luminous keyboard;
a light-emitting element located under the plural keys, and emitting a light beam;
a light guide plate located under the plural keys and arranged beside the light-emitting element, wherein the light guide plate comprises plural light-guiding parts for guiding the light beam to the plural keys; and
a supporting plate arranged between the plural keys and the light guide plate and connected with the plural keys, wherein the supporting plate comprises:
a plate body arranged between the plural keys and the light guide plate;
at least one opening running through the plate body and aligned with the corresponding light-guiding part, wherein after the light beam passes through the at least one opening, the light beam is projected to at least one key of the plural keys; and
at least one sheltering wall disposed on the plate body, aligned with the at least one opening and arranged beside the at least one opening, wherein the light beam and the corresponding light-guiding parts are sheltered by the at least one sheltering wall, wherein the at least one sheltering wall is a bent structure that is extended from the plate body, and the at least one sheltering wall is integrally formed with the plate body.

2. (canceled)

3. The luminous keyboard according to claim 1, wherein the luminous keyboard further comprises a switch circuit board, and the switch circuit board is disposed on the supporting plate, wherein when the switch circuit board is triggered by the plural keys, plural key signals are correspondingly generated.

4. The luminous keyboard according to claim 3, wherein the at least one key comprises:
a keycap located over the supporting plate and exposed outside the luminous keyboard, wherein the keycap comprises a light-outputting zone, the light-outputting zone is aligned with the opening, and the light beam is guided and projected to the light-outputting zone;
a connecting element arranged between the keycap and the supporting plate, wherein the keycap and the supporting plate are connected with each other through the connecting element, so that the keycap is movable upwardly or downwardly relative to the supporting plate; and
a triggering element arranged between the keycap and the switch circuit board, wherein when the triggering element is pushed by the keycap, the switch circuit board is triggered.

5. The luminous keyboard according to claim 4, wherein the connecting element comprises:
a first frame, wherein a first end of the first frame is connected with the keycap, and a second end of the first frame is connected with the supporting plate; and
a second frame connected with the first frame and swingable relative to the first frame, wherein a first end of the second frame is connected with the supporting plate, and a second end of the second frame is connected with the keycap.

6. The luminous keyboard according to claim 5, wherein the keycap further comprises plural keycap hooks, and the plural keycap hooks are protruded from an inner surface of the keycap, wherein the first end of the first frame and the second end of the second frame are connected with the plural keycap hooks.

7. The luminous keyboard according to claim 5, wherein the supporting plate further comprises plural supporting plate hooks, and the plural supporting plate hooks are bent structures that are extended from the plate body, wherein the second end of the first frame and the first end of the second frame are connected with the plural supporting plate hooks.

8. The luminous keyboard according to claim 4, wherein the switch circuit board comprises plural perforations, and the plural perforations are aligned with the corresponding light-outputting zones, wherein after the light beams are guided to pass through the perforations, the light beams are projected to the light-outputting zones.

9. The luminous keyboard according to claim 1, further comprising an illumination circuit board beside the light guide plate, wherein the illumination circuit board supports the light-emitting element and provides electric power to the light-emitting element.

10. The luminous keyboard according to claim 1, wherein the light-emitting element is a side-view light emitting diode.
